(19) United States
(12) Patent Application Publication
(10) Pub. No.: US 2014/0067399 A1
(43) Pub. Date: Mar. 6, 2014

(54) METHOD AND SYSTEM FOR REPRODUCTION OF DIGITAL CONTENT

(71) Applicant: MATOPY LIMITED, London (GB)

(72) Inventors: Samuel Oliver JEWELL, London (GB); Benjamin Hywel Carver, Holland Park (GB)

(73) Assignee: MATOPY LIMITED, London (GB)

(21) Appl. No.: 13/923,729

(22) Filed: Jun. 21, 2013

Related U.S. Application Data
(60) Provisional application No. 61/663,060, filed on Jun. 22, 2012.

(51) Int. Cl. G10L 13/08

(52) U.S. Cl. CPC G10L 13/08
USPC 704/260

(57) ABSTRACT

The present invention relates to a method and system of aurally reproducing visually structured content by associating specific audio formatting elements with visual formatting elements of the content. A method and system for reproducing visually structured content by associating abstract visual elements with visual formatting elements of the content is also described.

### CROSS REFERENCE TO RELATED APPLICATION

This application claims the benefit from U.S. Provisional Application No. 61/663,060, filed Jun. 22, 2012, which is incorporated herein by reference.

### FIELD OF INVENTION

The present invention is in the field of content reproduction. In particular, but not exclusively, the present invention relates to a method and system for aural reproduction of digital content.

### BACKGROUND

To listen to text-based information from a computer or smartphone, or from the Internet today, users typically utilise Siri™ (or equivalent technology on the smartphone platform) or a screen-reader (typically on desktop, for visually impaired people).

Both of these options typically use only a single voice to speak all content, omitting all contextual information provided by changes in font, formatting or colour of the text.

Extra cues and formatting information are conveyed through speaking extra speech (such as “link—Google”).

Existing systems, therefore, have limited and intrusive mechanisms for conveying visual information about the content.

Accordingly, where the visual formatting of the content cannot be viewed, or where the user is visually-impaired, there is a loss of information.

It is an object of the present invention to provide a method and system for reproduction of digital content which overcomes the disadvantages of the prior art, or at least provides a useful alternative.

### SUMMARY OF INVENTION

According to a first aspect of the invention there is provided a method of aurally reproducing visually structured content by associating specific audio formatting elements with visual formatting elements of the content.

The method may include the step of aurally reproducing the content using the associated audio formatting elements. Aural reproduction of the content may include layering of audio related to multiple audio formatting element types. The audio formatting element types may include background music, voice, sound effect, and audio effect.

A processor may associate the audio formatting elements with visual formatting elements in accordance with a set of rules.

Audio formatting elements may be associated with visual formatting elements in accordance with a scoring method.

Elements of content may be ordered in accordance with a score assigned to each element using a scoring method

Either scoring method mentioned above may include the step of calculating a score for each element of content using attributes of one or more visual formatting elements associated with that element of content.

The method may further include the step of receiving input during aural reproduction to navigate within the content. The input may specify navigation to different portions of the aurally reproduced content based upon visual formatting elements. The input may be a single user action. The input may be received from a user control device, said user control device including one or more selected from the set of: tactile buttons and an accelerometer.

The content and/or context of the content may be used to associate specific audio formatting elements with visual formatting elements of the content.

The audio formatting elements may be one or more selected from the set of: voice type, number of voices, voice pitch, audio speed, music, sound effects, sound location, audio effect, and number of instruments playing.

A specific audio formatting element may be associated with a combination of visual formatting elements.

The content may be reproduced visually in accordance with the method of later described aspect.

The method may include the step of receiving input from the user to dynamically modify the speed of the aurally reproduced content during reproduction. The method may also include the step of visually displaying an indicator of the speed.

According to a further aspect of the invention there is provided a system for aurally reproducing visually structured content including:

a processor configured for generating audio from the content using associations between visual formatting elements of the content and audio formatting elements.

According to a further aspect of the invention there is provided a system for aurally reproducing visually structured content including:

a processor configured for associating visual formatting elements of the content and audio formatting elements.

According to a further aspect of the invention there is provided a method of reproducing visually structured content by associating abstract visual elements with visual formatting elements of the content.

The method may include the step of visually displaying abstract visual elements from the structured content using the association.

According to a further aspect of the invention there is provided a system for reproducing visually structured content including:

a processor configured for displaying abstract visual elements from the content using associations between visual formatting elements of the content and abstract visual elements.

According to a further aspect of the invention there is provided a system for reproducing visually structured content including:

a processor configured for associating visual formatting elements of the content and abstract visual elements.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flowchart illustrating a method in accordance with an embodiment of the invention;

FIG. 3: shows a diagram illustrating an example of data flow in a system in accordance with an embodiment of the invention;

FIG. 4: shows a flowchart illustrating an audification method in accordance with an embodiment of the invention;

FIG. 5: shows a flowchart illustrating another audification method in accordance with an embodiment of the invention;

FIG. 6: shows a flowchart illustrating a prioritisation method in accordance with an embodiment of the invention;

FIG. 7: shows a flowchart illustrating a visualisation method in accordance with an embodiment of the invention; and

FIG. 8: shows screenshots illustrating a visualisation method in accordance with an embodiment of the invention.

### DETAILED DESCRIPTION OF PREFERRED EMBODIMENTS

The present invention provides a method and system for aurally reproducing visually structured content by associating visual formatting elements of the content with specific audio formatting elements.

In this description, the association process will be termed “audifying” content.

The invention will be described in relation to use with web-page content, but it will be appreciated that any other structured content could be used including, but not limited to, HTML (HyperText Markup Language), HTML including related CSS (Cascading Style Sheet) and JavaScript, XML (eXtensible Markup Language), or JSON (JavaScript Object Notation).

In one embodiment, the invention receives content by interacting with an Application Programming Interface (API), such as a web-service API.

Embodiments of the invention may also include one or more of the following aspects:

### 1. Prioritisation of the Information.

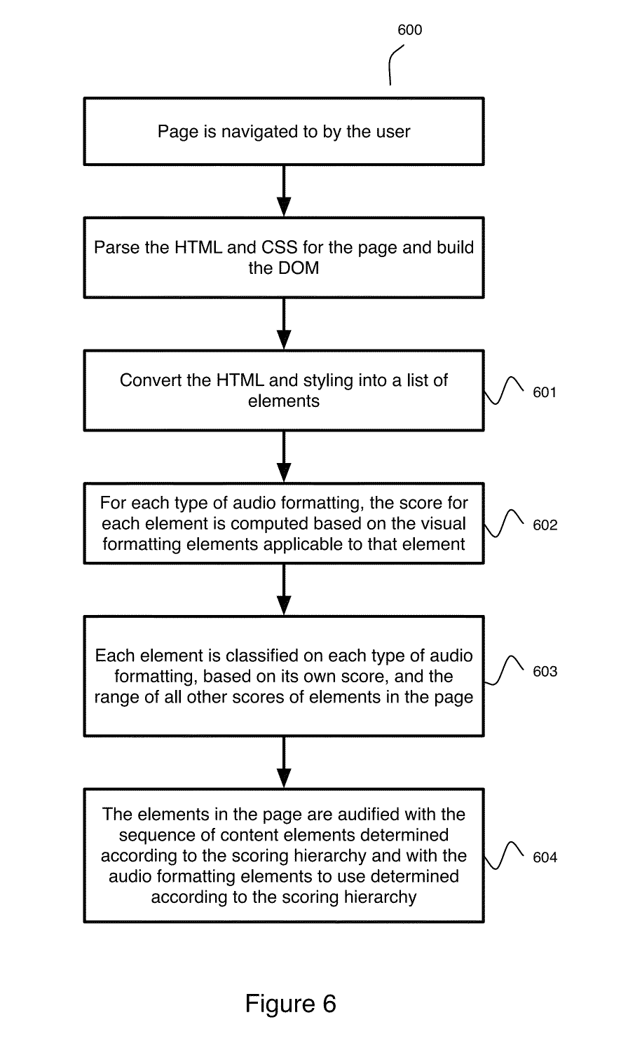

This aspect provides the advantage of delivering most important content on the page (or the ‘meat’ of the page) to the user first. The information within the page is ordered by the system in order of decreasing importance and then audibly delivered to the user, simultaneously making it navigable and easy for the user to find their way around. Navigation options may be found in the same place and made to be very easy to access—for example, with just one gesture/keystroke/click/spoken command. Further detail of the prioritisation feature will be described later in this document with reference to FIG. 6.

### 2. Visual Feedback Elements, and Visual Controls.

In this aspect, the visual content (such as text) may be replaced by abstract elements (such as shapes) to represent different sections or types within the content and the abstract elements may be displayed on screen to aid user interaction. Therefore, a visual display can augment the user interface—thus the user can navigate the entire experience through audio alone, or they can make use of the visuals—the abstract version of the content—for extra feedback and understanding, and faster control. The abstract elements may consist of different coloured blocks and lines on the screen, but it will be appreciated that other abstracted visuals such as images, logos, or shapes—static or animated—could be used. Preferably, the abstract elements contain no text content.

### 3. Control Through the WiiMote™ (and Smartphone)—Through Buttons and Gestures.

User interaction with the system may occur through a WiiMote™, Kinect™ or similar device. The WiiMote™ is an example of a user interface device which may be particularly useful for interacting with a stream of audio, as it has tactile buttons (and thus is “eyes-free”—the user does not have to look at it to use each of the buttons) and the ability to control the interface through gestures (using the accelerometers in the device—which is also “eyes-free”). The WiiMote™ does not have a screen, but this is no disadvantage, as a screen is not required when surfing through speaking/listening alone. The WiiMote™ may be connected via Bluetooth to a computer executing a method of the invention, or to a smart-phone device when being used on the go or when travelling. It will be appreciated that other wireless (or wired) input devices with tactile interfaces and/or accelerometer-based gesture inputs can be used in place of the WiiMote™.

### 4. Enhanced Audio Content Navigation and Interaction Methods.

### a) Quick Document Navigation—

This aspect provides the ability to jump straight to the next or the last change in formatting with a single arrow key, button press or flick-gesture of the WiiMote™, for example. Other features of document can be jumped immediately to such as next sentence, next paragraph, next heading or next section (and backwards as well).

### b) Dynamic Control of the Pace of the Text-to-Speech System (TTS)—

This aspect enables a user to dynamically change the speed of the TTS during delivery of the audio content. This may be achieved through a “Speedometer” control, which dynamically changes the speed of the voice. This has the advantage of providing a similar freedom to the freedom of a user visually scanning a page while reading. The “Speedometer” may be visually displayed on a screen, and the voice speed may be changed immediately with a single click of the mouse, keyboard or WiiMote™.

### c) Audio Search—

This aspect provides the ability for the user to search through the content. For example, a system incorporating this aspect may use speech recognition to detect a user-spoken search term, and then receive input from the user to either search the current page, search Google, or search just links within the page using the search term.

### 5. Control Through Touchscreen Gestures.

This aspect provides for user input via swipes, pinches and other touchscreen interactions.

The present invention may also provide a method and system for visual reproduction of visually structured content by associating visual formatting elements of the content with abstract visual elements.

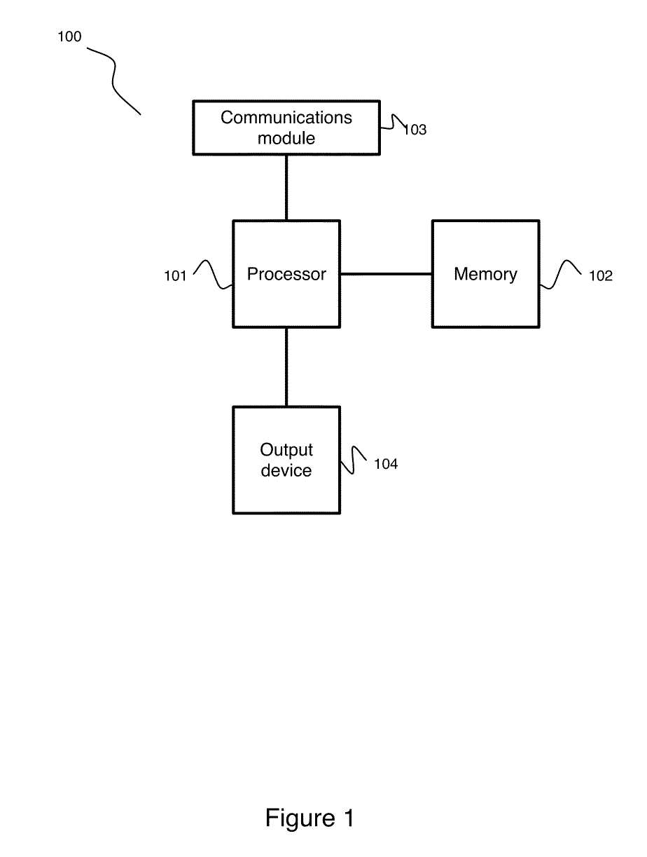

Referring to FIG. 1, a system 100 in accordance with one embodiment of the invention will be described.

The system includes a processor 101 and a memory 102. The processor 101 may be configured to convert visually structured content into aurally reproducible content (processed content) using association data associating visual formatting elements within the visually structured content and audio formatting elements.

The system 100 may also include a communications module 103 configured to receive visually structured content from a server over a communications network. The communications module 103 may also be configured to receive the association data from the server.

In one embodiment, the processor 101 is further configured to generate the association data using an association method.

The memory 102 may be configured for storing the visually structured content and the association data.

The system 100 may include an output device 104. The output device 104 may include an audio generation apparatus such as a digital to analogue converter and a speaker. The output device 104 may be configured to aurally reproduce the processed content for receipt by a user.

In one embodiment, the processor 101 is configured for converting visual formatting elements within the visually structured content into visually abstract elements. The processor 101 may be further configured for generating association data associating visual formatting elements within the visually structured content and abstract visual elements. The system 100 may also include a display device and the visually abstracted elements are displayed to a user.

It will be appreciated that the functions of the system described above may be deployed in a distributed environment. For example, the output device may be a remotely located at a user device, and the processor may communicate with the output device across a communications network, such as the Internet.

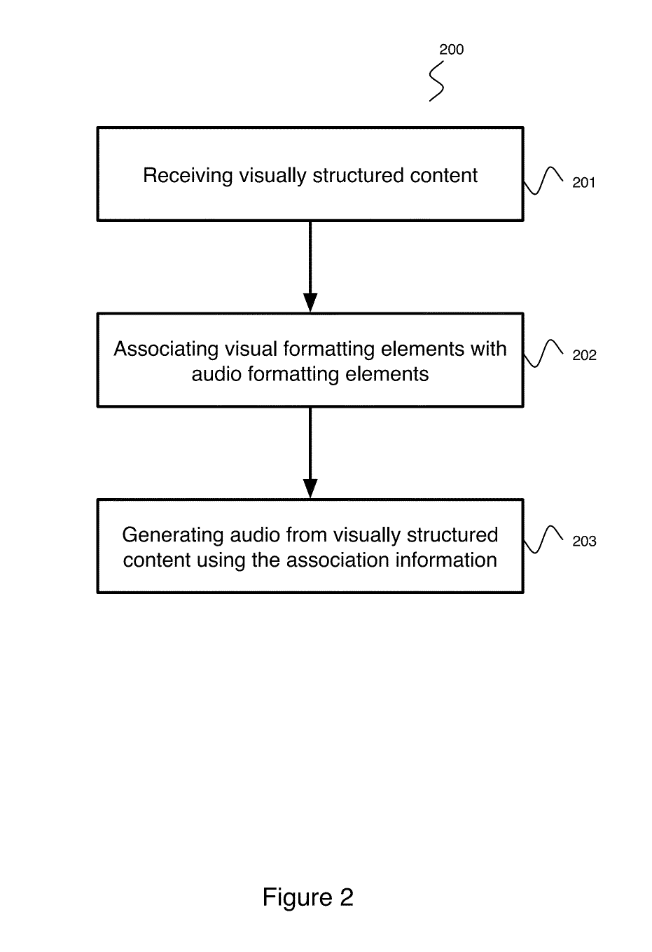

Referring to FIG. 2, a method 200 in accordance with one embodiment of the invention will now be described.

In step 201, visually structured content is received (for example, by the communications module 103).

In step 202, visual formatting elements are associated with specific audio formatting elements (for example, by the processor 101). For example, a heading may be defined to be a different voice from a subheading, or a link a different sound effect compared to a button.

The visual formatting elements may represent the graphic design of the content.

In one embodiment, there is not an association for every visual formatting element. In other words, some visual formatting elements may be ignored.

In one embodiment, the associations between the visual formatting elements and the audio formatting elements may be further defined by context within the visually structure content. For example, the same visually formatting element may correspond to a different audio formatting element, if the content formatted is displayed within white space then if the content formatted is displayed amongst other content, or if there is a particular contrast ratio formed by the foreground/background colour scheme of that particular content.

In one embodiment, an audio formatting element may be the absence of audio or the muting of currently playing audio.

In step 203, audio is generated from the visually structured content using the association data (for example, by the processor 101). The audio may be output via an output device 104 such as a speaker or speakers, or headphones.

In one embodiment, the output device 104 is remotely located at a user device.

In one embodiment, the visual formatting elements are associated with abstract visual elements, and the visually structured content is displayed as abstract visual content using the association information on a display device.

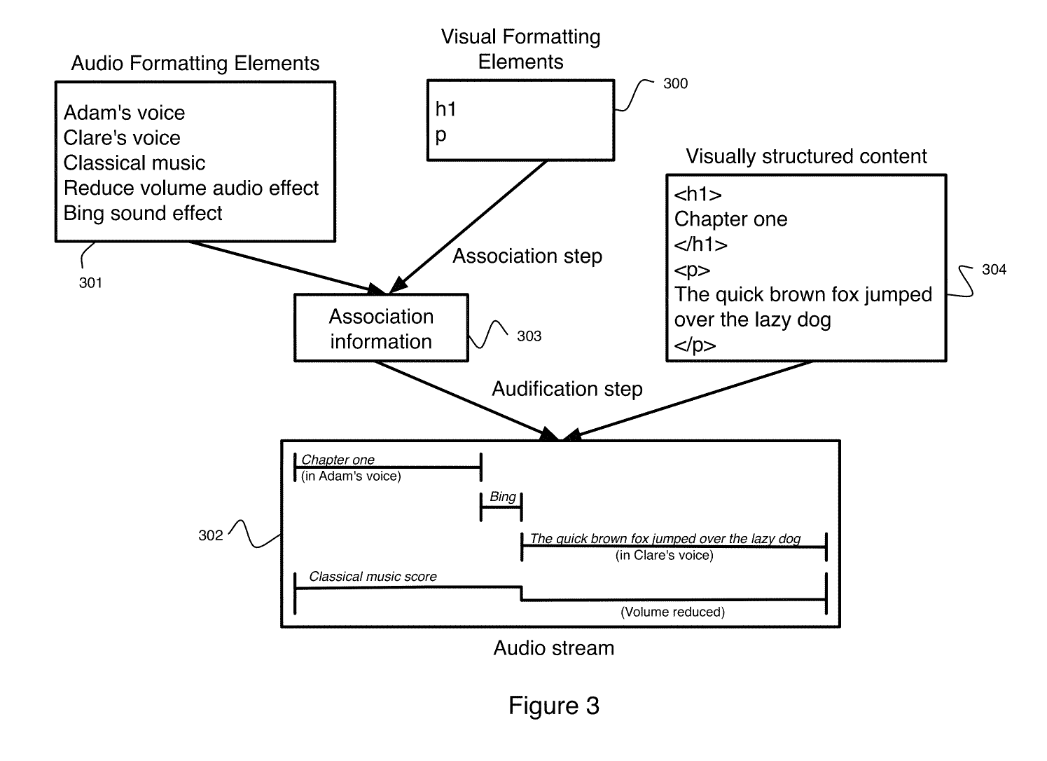

A detailed description of a system in accordance with a further embodiment of the invention will now be described with reference to FIG. 3.

By way of background, a brief description of visual formatting will be provided.

Graphic design elements, and from a more general perspective, the context that is added to content by web designers, is achieved through tags and mark-up in the HTML and/or CSS and/or extra JavaScript functionality.

For example, changes to the appearance of content might be the product of HTML tags (H1, p, div etc.) and also CSS styling (color, font-size etc).

In this embodiment, the spoken audio content and the additional audio cues/music will be generated by the system based on differences in HTML and/or CSS (and/or JS).

In one embodiment, the system includes a rule that if the visual formatting 300 changes, then the audio formatting 301 changes, and if the visual formatting 300 stays the same, then the audio formatting 301 stays the same too. In a more specific embodiment—each single change in the graphic design may be consistently reflected in one thing changing in the audio stream 302. For example:
each font change consistently leads to a change in the voice used (say “Adam's voice” to “Clare's voice”), for speech synthesis; and
each colour change consistently leads to a change in the pitch of the voice.

Thus links 303 are made (equivalency) between the ‘controls’ that a graphic designer uses (font, colour, size, layout, etc) and the audio-design controls of the system (which voice is speaking, voice pitch, voice speed, background music etc).

Additionally in some cases content itself or context may be utilised by the system when associating audio formatting. For example, if the web-pages are all associated with one brand identity, then all sound effects on those pages may be tailored (i.e. a unique library of sounds) for that particular brand, or all web-pages at a particular domain may have related sound effects.

Thus changes to the formatting and the styling of web content are parsed and located, and used to drive changes in the audio formatting of the spoken content.

When a piece of content is encountered which is either tagged or styled differently from the last piece, the system can change one or many of the following attributes of the sound, to reflect the fact that the context and meaning of the information has changed slightly. For example:
The voice itself (man/woman or child speaking, USA accent or UK, etc);
The number of voices speaking (sometimes 2 voices or a congregation of voices could be used, e.g. to speak links);
The voice pitch (and pitch of all sounds);
The speed of speech (and speed of all sounds);
Background music (or indeed foreground music);
Sound effects and audio cues (could be short/instantaneous, or longer musical cues like a background buzzing, or melodies or chords playing in the background);
Location of where the sound is coming from—i.e. panning left-right between the left and right speakers;
Effects applied on top of the sound—for example reverb or echo—and/or the amount of these effects (the wetness/dryness of the sound). For example, a homepage might be very echoey, a page just below that slightly less echoey, and a page much deeper into a site could have no echo at all applied to the sound; and
Number of instruments playing—types of instruments playing (timbre of the sound) and the key a tune is played in (Major/Minor/other).

The system can generate audio formatting which results in a sequential change to the audio stream 302—such as a “bing” sound when an “option” within the structure of the content is encountered. In one embodiment, the system can also, or alternatively, provide for the layering of sounds changing in parallel—background music for example (a particular instance is when the background music continues when a story within a web-page content is activated, but it undergoes “Ducking”—its volume is reduced to allow the user to focus on the spoken content).

Content in its “audified” form may, in some embodiments, consist of many sounds layered on top of one another. For example, an audified web-page may have:
A background tune (or more than one tune);
A voice speaking (or more than one voice);
A sound effects layer playing to imply whenever a link is encountered (or perhaps functional changes to text);
Another effects layer to imply aesthetic changes (e.g. when text is bold or italicised); and/or
An audio effect applied to some or all of the sounds above, e.g. applying an echo (either to just the voice or to the voice and to the tune).

Thus as the system encounters different formatting changes in the HTML 304 (which may be modified by CSS or JS) and/or changes to the content itself or the type/location of the web-page, some aspects of the layered sounds may change instantaneously, while other aspects might be left unchanged.

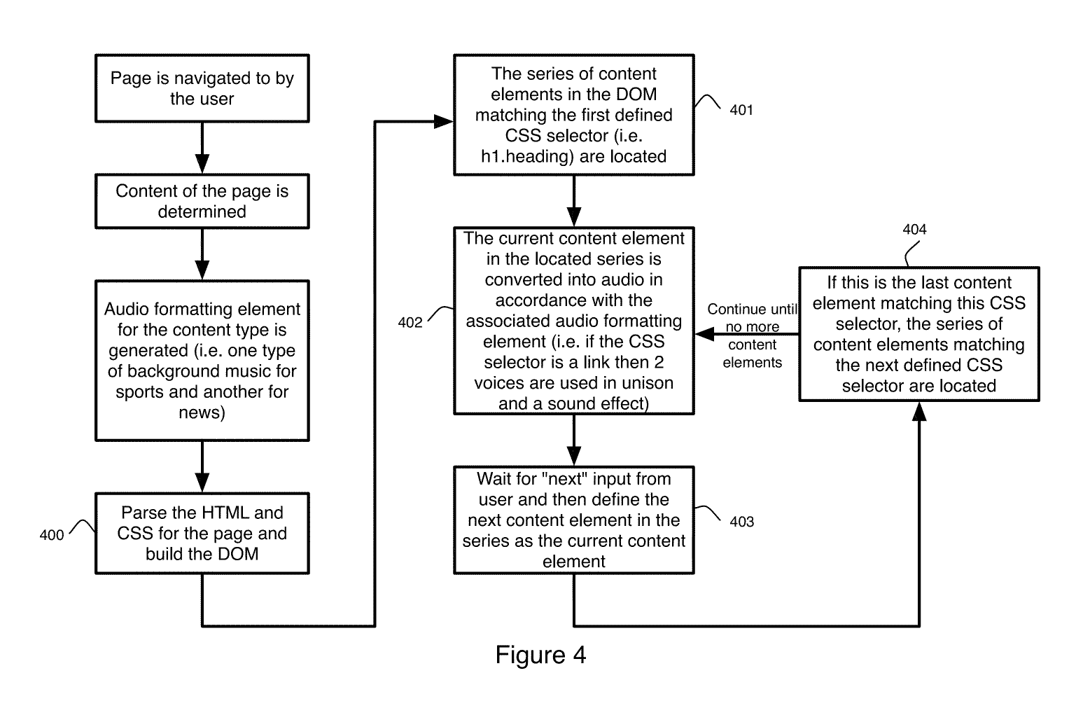

One method for audification of content in accordance with an embodiment of the invention will now be described with reference to FIG. 4.

In this method, audio formatting is predefined for specific websites.

This method requires a programmer to manually write a set of instructions for each site that is desired to “audify”, one by one. Similar pages within a larger site which follow the same HTMUCSS structure can all be “audified” without extra input from the programmer once the first page has been done.

In this case, the links that are made (the equivalency) between the ‘controls’ that a graphic designer uses (font, colour, size, layout) and the “audio design” (audio formatting) controls (which voice is speaking, voice pitch, voice speed, background music etc), are rules that are followed by the programmer as he/she hard-codes the instructions.

To create the instructions, the programmer may proceed in accordance with the following steps:
1. The programmer manually identifies all of the different graphical/typographic formats on a webpage, and records the part of the HTML/CSS code which has changed for each change in the graphical/typographic format (and indeed he/she also records the HTML/CSS code which is unchanged when the typography/formatting is unchanged);
2. The programmer then chooses an audio format to represent each typographic/graphical format; and
3. Then the programmer chooses the order in which the content is presented to the user. For example:

| Graphical Formatting - | | | | |
|---|---|---|---|---|
| selector or identifier | | | | |
| | | . . . and | Equivalent Audio | |
| Content type | HTML tag... | selector | Formatting | Sequence |
| Webpage | url | | Background | |
| address | | | music | |
| Heading | <h1 | (h1#xxxxx) | Man's voice | 2 |
| | id=”xxxxx”> | | (Adam) | |
| Subheading | <h2> | (h2) | Woman's voice | 3 |
| | | | (Clare) | |
| Paragraph | <p | (p.xyz) | Man's voice | 4 |
| | class=”xyz”> | | (Dave) | |
| Link | <a | (a[href= | 2 voices in | 1 |
| | href=”xxx”> | ”xxx”]) | unison + “bing” | |
| | | | FX alongside | |

In this example above, the programmer has defined that the <a href=“xxx”> tagged link(s) is spoken first. A system of an embodiment of the invention parses the HTML from the site, finds the content tagged with <a href=“xxx”> and “speaks” this using two voices in unison, and a “bing” sound effect alongside each one.

Then the programmer has defined that <h1 id=“xxxxx”> is spoken next. When the two voices reach the end of the <a href=“xxx”> link(s), or when the user skips forwards, the system looks in the parsed HTML DOM for the <h1 id=“xxxxx”> content, and starts speaking this with Adam's voice.

After this the system speaks all content tagged with <h2> in Clare's voice. Finally it speaks all links tagged with <p class=“xyz”> in Dave's voice. At any point the user can skip forwards or backwards—they do not need to wait for the whole of the content to finish being read out. If the user skips forwards or back, then the system immediately jumps to “speaking” the next or previous piece of content (following the order specified by the programmer) and audifies it as per the audio formatting instructions (again as specified by the programmer).

The system then processes this audification in accordance with the following steps:
a) Parse 400 the site's HTML and form the DOM (Document Object Model);
b) Identify 401 from the instructions which element will be read first (what tags and parents this element has);
c) Find this element, and save the content as a string variable;
d) Identify 402 from the instructions what audio formatting this element should have;
e) “Audify” the content in the string in accordance with identified formatting—which voice, which sound effects and what other audio to use;
f) Speak/play this audified content.
g) Input 403 may be waited for from a user (i.e. “Next”) before steps c) to f) are repeated 404 for all further elements that the programmer has chosen to be audified: Each element is found and saved into a string, and then audified in the sequence and with the formatting defined within the instructions by the programmer.

In one embodiment, input from a user can be received during step f) above which will trigger immediate speaking/playing of the next audified content. User input may also trigger movement not to the next audified element but may jump to other audified elements depending on the input and/or upon configuration. For example, “back” input may replay the previous audified element. Consquently not all audified elements may be spoken/played by the user.

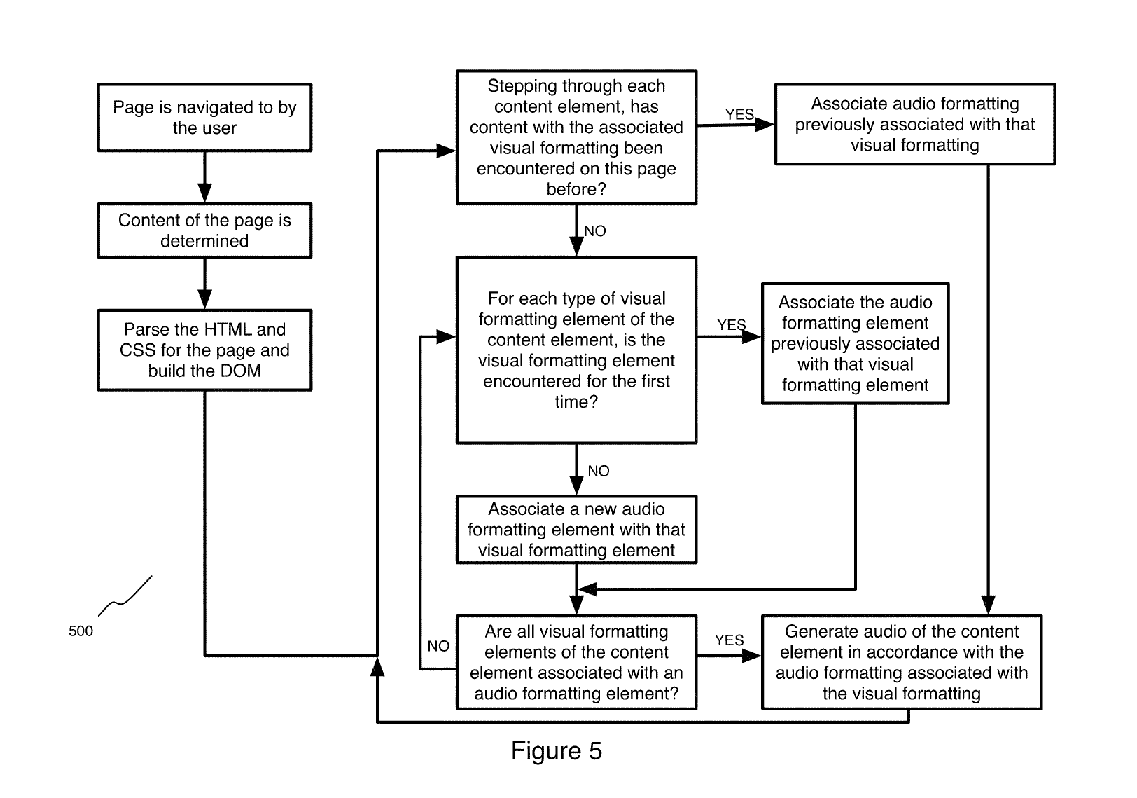

An alternative method 500 for audification of content in accordance with an embodiment of the invention will now be described with reference to FIG. 5.

This method uses an automatic system for generating audio formatting.

The content may be audified in accordance with the automated process shown in FIG. 5.

Thus the method can parse any website and audify the content.

A system operating in accordance with this method will generate audio for the first piece of content with the first available voice and other audio. Then each time afterwards that it encounters an element on the page, it checks to see whether the HTML tagging and CSS styling have changed. If they have, it changes the audio formatting accordingly. It may utilise rules to change the audio formatting—for example:
New font/size/colour of text: use a new voice;
New layout/positioning: position the sounds in a new location;
New background colour or colour scheme: use a new audio effect—for example, a new level of echo;
New function or interaction encountered (checkbox/radio-button): use a new sound effect; and
Content itself is on a new theme or subject: use new background music.

The above rules may be defined and ordered in specific ways for specific types of content (i.e. content from one website).

If, for example, two of the above change in the HTML/CSS, then two things will change in the audio formatting also. If the system encounters something it has seen before on the same page (such as returning to a colour scheme that existed at the top of the page) then it will return to the audio formatting that it had for that colour scheme at the top of the page.

The resulting audio formatting may be kept in a data structure in memory, or it may be stored in a marked-up format file and transferred to the user, or it may be streamed to the user.

Thus the system remembers/records all of the audio-formats and all of the element tags that it applies as and when it does so, building up a list, so that it knows when it encounters something it has seen before and can go back and use the same audio styling as it had previously. The table below shows the process the system goes through:

| | | Newly set? Or | |
|---|---|---|---|
| Which | | already | |
| element | Graphical | specified | |
| encountered | formatting | on this page | Audio formatting |
| First | <h1> - Arial in dark | New | Adam's voice |
| | blue | | |
| First | Left aligned | New | Left ear |
| First | yellow background | New | Music of springtime |
| Second | <h1> - Arial in dark | Already set | Adam's voice again |
| | blue | | |
| Second | Right aligned | New | Right ear |
| Third | <href> link | New | 2 voices + “Bing” |
| | | | sound |
| Third | yellow background | Already set | Music of springtime |
| | | | again |
| Fourth | as for Third | Already set | as for Third |
| | element | | element |
| Fifth | as for Third | Already set | as for Third |
| | element | | element |
| Sixth | <p> | New | Clare's voice |
| Sixth | Left aligned | Already set | Left ear again |

A method 600 for prioritisation of content in accordance with an embodiment of the invention will now be described with reference to FIG. 6.

This method for prioritisation of content specifies the sequence of the audified content and the formatting used to audify the content.

In one embodiment, the method assigns a level of priority from high to low to all visual formatting elements within the content (i.e. on the web-page). This priority level can then be used to either or both define the sequence in which the content is presented, and assist in defining the association of audio formatting elements with visual formatting elements.

In step 601, the HTML page is converted, together with associated styling information and scripts, into a list of elements, together with the textual content they contain, and styling information about how they would be displayed in the browser (font, font size, position on the page, etc). This process is currently utilised by web browsers to determine how to visually display content.

In step 602, for each audio formatting type for each element, a priority score is calculated using a scoring system.

For example, for the type of voice, the scoring system may be based on both visual formatting elements text size and text colour. This may lead to the following equation: “voice type” score=3*“text size”−“text colour contrast with background”.

In step 603, each element is classified for each type of audio formatting, based on its own score and the range of all other scores of elements on the page. For example, if there are 3 voices types available, and 30 elements on the page, the 10 with the highest voice type score will be read with one voice, the 10 with the next highest voice type score are read with another voice and the 10 with the lowest voice type score are to be read with another voice. Alternatively, for example, with elements ordered by priority from 1 to 10, elements 1, 4, 7, 10 are spoken in a FIRST voice, elements 2, 5, 8 are spoken with a SECOND voice, and elements 3, 6, 9 are spoken with a THIRD voice.

The list of elements may be ordered by their priority scores, then read through in order of priority, using the audio formatting determined by the audio formatting classification process described above in step 604.

In one embodiment, the elements are ranked rather than scored.

In one embodiment, elements may be scored or ranked within one of a plurality of groups, and these groups may in turned be scored or ranked.

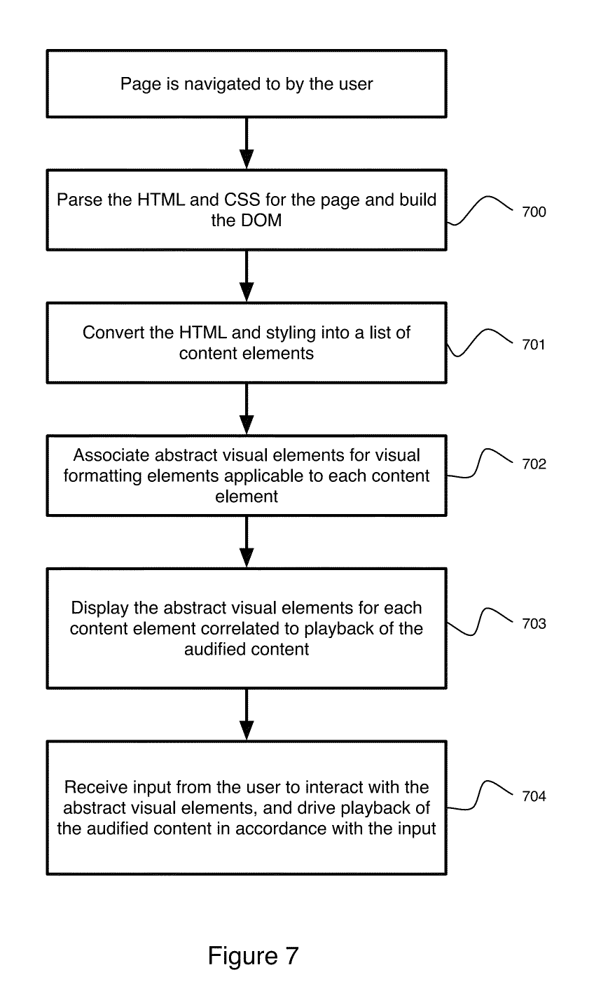

With reference to FIG. 7, a method and system for abstracting content/elements into text-free visuals in accordance with an embodiment of the invention will be described.

When a sighted person uses a desktop operating system, they can choose to do so with the sound effects switched on or off. Switched on, the sound effects give extra feedback, improving the user experience somewhat (making it marginally faster, easier and clearer to understand what is happening), but switched off the system is still 100% useable.

Switching from a reading to a listening based user interaction, in this method and system the optional sound effects from the traditional reading/writing interaction can be “replaced” with optional “visual effects” for audio-based user interaction.

Therefore, the audification methods and systems described herein may include a display device configured to generate visual feedback, in some sense analogous to sound effects for people using desktops. It will be appreciated that this visual feedback method and system is optional to the audification methods and systems. However, visual feedback may, in some circumstances, improve the user experience in general, making it easier to learn or understand, and faster and easier to use.

When a web-page is parsed and a DOM formed in step 700, the system is able to determine in step 701 which content elements are available for “audification”. Whichever methods for audification described are used, there will be a total number of elements available to interact with and listen to. In addition to the elements on the web-page, there might be extra options for user interaction, such as a “back” key to return to a previous page.

In step 702, an association is made by the system between abstracted visual elements (for example, abstract blocks) and visual formatting elements which are applicable to the content elements.

In one embodiment, there is not an association for every visual formatting element. In other words, some visual formatting elements may be ignored.

The system may use a rule that if the visual formatting of the original text page changes, then the look of the abstract block (which represents the original content) will change too. And if the visual formatting of the original text stays the same, then the look of the abstract block stays the same too.

In one embodiment, the system uses a rule that one change to the visual formatting of the original text (such as a font change) is consistently reflected in one thing changing in the look of the abstract coloured blocks (for example, the indent of the block changing); thus colour changes to the original text (as another example) would consistently be shown by one other thing changing in the look of the abstract coloured blocks (for example, rounding/bevelling the corners of the blocks). Thus links are made (equivalency) between the ‘controls’ that a graphic designer uses to visual design the original text document (font, colour, size, layout) and the look of the abstract coloured blocks (hue, saturation, brightness, size, alignment, corner detail, texture).

In one embodiment, the system also associates specific types of content with specific abstract visual elements. For example, if the content relates to “football”, a specific abstract visual element may be associated with the content (i.e. an abstract football).

In step 703, the system displays the abstract visual elements for the structured content based upon the associations defined in step 702.

In step 704, the system may receive input from the user to interact with the abstract visual elements to drive selection of content to speak or activation of links.

In one embodiment, the system represents all content available on the web-page on the display by an abstract visual element (for example, abstracted block), such that a user can see how much or how little content there is, and how far through the web-page they are (or which options they have interacted with already vs which ones they are still yet to interact with).

In one embodiment, the system represents available ‘moves’ from the user's current location on the display, so the user can see all possible routes away from the current audified content they are listening to.

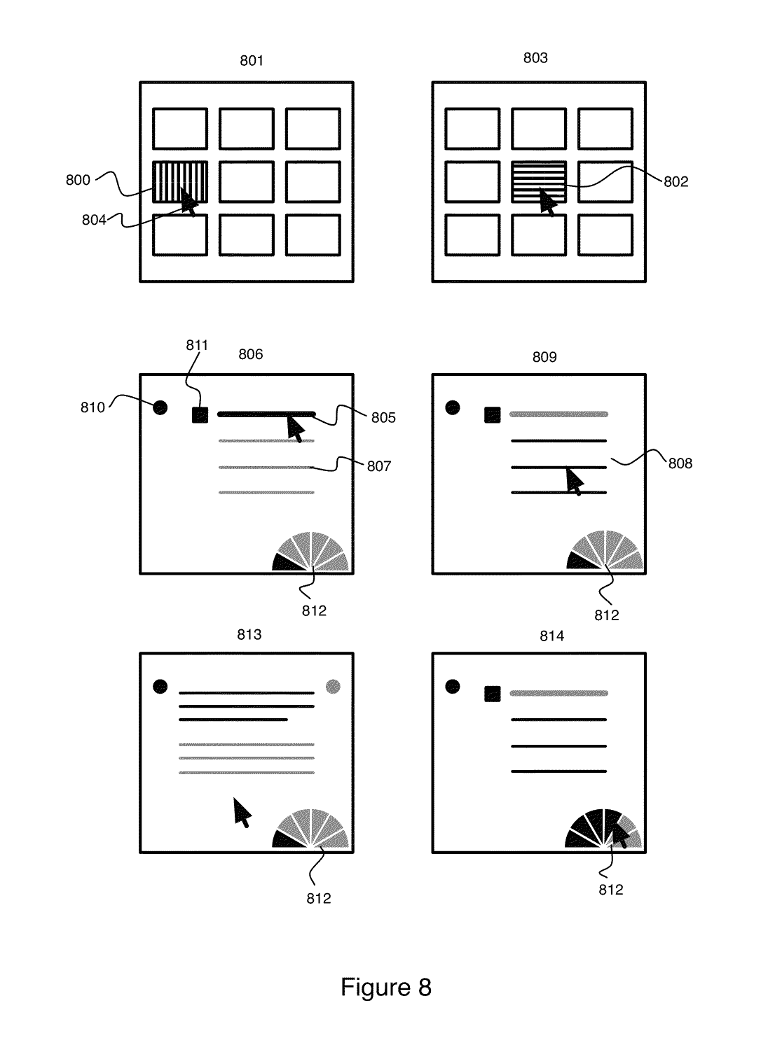

In FIG. 8, an example of structured content reproduced by the system above will be described. The content is a homepage (in this case for a mobile version of the BBC sport website) which has been audified. There are nine sections of news which can be selected at this point—nine links are spoken to the user one by one, so to reflect this the abstracted visuals that have been generated are nine blocks 800 on the screenshot shown at 801. As the user hears each of the nine options, another of the blocks 802 lights up in a different colour, to show transition from one piece of content to another shown at screenshot 803.

The system may provide for mouse (or cursor input device) interaction with the information. The cursor 804 may be defined at a larger size than typical cursor sizes (for example, 10× its typical size), which may provide faster and clearer visual feedback and interaction. As the user hovers the mouse cursor over each coloured block, the block may light up and that link is spoken, giving the content a spatial location for users who would rather interact with the information in this way.

Once a sub-section of the page has been chosen by a user, the first story's heading and subheading are next audified. The heading is spoken—and is represented by a large green bar 805 at the top of the screenshot 806. If the user wants to hear more, they can select down (for example, on a keyboard or other input device such as a WiiMote™), or click on grey bars 807 below (an abstracted form for a few lines of text). At this point the grey bars will turn white as in 808 shown in screenshot 809, and the sub-heading of the article will be spoken to the user.

In display 806, a red circle 810 is the “home” button, which can take users back to the home page at any point. The green block 811 is a link to the story in full. Thus if the user presses “enter” or clicks the green block 811, the full story loads and begins speaking. The visual formatting elements of the story may also be represented as abstract visual elements as illustrated in 813. For example, each paragraph in the story may be visually indicated by a series of grey bars with the last bar shorter than the others to indicate a paragraph break. User input may be received to override the linear audio playback of the story to select another paragraph for immediate audio playback.

Also shown is a semi-circle 812 divided into segments, at the bottom right of the screenshots 806, 809, 813, and 814. This is a speedometer/accelerometer 812 which indicates the current speaking speed of the audified content, and can be clicked on to change the speed as shown in display 814.

It will be appreciated that the above method for visual abstraction may be used separately from the audification method and system.

In one embodiment of the invention, interaction with the audified content generated by a system of the invention may be controlled with a Nintendo WiiMote™, an iPhone™, an Android™, or other smart-phone or device comprising an accelerometer.

Left/right/up/down inputs can be provided either by pressing these buttons on the controller, or with a flick of the wrist in this direction (on both WiiMote™ and iPhone). As earlier described, the WiiMote is a useful input device for interacting with speech, as it is completely tactile and not at all visual.

When pressing left/right/up/down (or making the equivalent wrist flicks) the system receives the command and will skip to playing the next (or the last) piece of content on the page. This may be the next sentence or next paragraph formatted with the same formatting element, or content formatted with the next (in sequence) formatting element on the page. This may facilitate fast navigation around the document in a way that makes intuitive sense—particularly because when the user flicks to the next item, they can realise they are in a different section because the voice has changed.

It will be appreciated that all the above methods and systems may be implemented with software executing within one or, in parts, across a plurality of computing devices, or within hardware itself. For example, at least some of the audification and visual abstract methods described may be implemented as a mobile application on a mobile device such as a smart-phone.

A potential advantage of some embodiments of the present invention is that complexly structured visual content can be processed into an audio format for users without losing much information residing in the complexity of the structure. Accordingly, users may require only audio hardware to receive the content. Furthermore, a potential advantage of some embodiments of the present invention is that users can utilise similar control over aurally reproduced content as they can over visually reproduced content.

A further potential advantage of some embodiments of the present invention is that complexly structured visual content can be processed into a visually simplified format for users. Accordingly, key structural information of the content can be displayed within a simpler display. Such simpler displays may facilitate complex interaction by users with audified content.

A further potential advantage of some embodiments of the present invention is the accessibility of visually structured content is improved for sight-impaired individuals.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of aurally reproducing visually structured content by associating specific audio formatting elements with visual formatting elements of the content.

2. A method as claimed in claim 1 including the step of aurally reproducing the content using the associated audio formatting elements.

3. A method as claimed in claim 2 wherein aural reproduction of the content include layering of audio related to multiple audio formatting element types.

4. A method as claimed in claim 3 wherein the audio formatting element types include background music, voice, sound effect, and audio effect.

5. A method as claimed in claim 1 wherein a processor associates the audio formatting elements with visual formatting elements in accordance with a set of rules.

6. A method as claimed in claim 1 wherein audio formatting elements are associated with visual formatting elements in accordance with a scoring method.

7. A method as claimed in claim 1 wherein elements of content are ordered in accordance with a score assigned to each element using a scoring method

8. A method as claimed in claim 6 wherein the scoring method including the step of calculating a score for each element of content using attributes of one or more visual formatting elements associated with that element of content.

9. A method as claimed in claim 1 including the step of receiving input during aural reproduction to navigate within the content.

10. A method as claimed in claim 9 wherein the input specifies navigation to different portions of the aurally reproduced content based upon visual formatting elements.

11. A method as claimed in claim 9 wherein the input is a single user action.

12. A method as claimed in claim 9 wherein the input is received from a user control device, said user control device including one or more selected from the set of: tactile buttons and an accelerometer.

13. A method as claimed in claim 1 wherein the content and/or context of the content is used to associate specific audio formatting elements with visual formatting elements of the content.

14. A method as claimed in claim 1 wherein the audio formatting elements are one or more selected from the set of: voice type, number of voices, voice pitch, audio speed, music, sound effects, sound location, audio effect, type of instruments playing, and number of instruments playing.

15. A method as claimed in claim 1 wherein a specific audio formatting element is associated with a combination of visual formatting elements.

16. A method as claimed in claim 1 including the step of receiving input from the user to dynamically modify the speed of the aurally reproduced content during reproduction.

17. A method as claimed in claim 16 including the step of visually displaying an indicator of the speed.

18. A system for aurally reproducing visually structured content including:
a processor configured for generating audio from the content using associations between visual formatting elements of the content and audio formatting elements.

19. A system for aurally reproducing visually structured content including:
a processor configured for associating visual formatting elements of the content and audio formatting elements.

20. A method of reproducing visually structured content by associating abstract visual elements with visual formatting elements of the content.

21. A method as claimed in claim 22 including the step of visually displaying abstract visual elements from the structured content using the association.

22. A method as claimed in claim 22 wherein the content and/or context of the content is used to associate specific abstract visual elements with visual formatting elements of the content.

23. A method as claimed in claim 1 wherein the content is reproduced visually from the structured content by associating abstract visual elements with visual formatting elements of the content.

24. A system for reproducing visually structured content including:
a processor configured for displaying abstract visual elements from the content using associations between visual formatting elements of the content and abstract visual elements.

25. A system for reproducing visually structured content including:
a processor configured for associating visual formatting elements of the content and abstract visual elements.
